(19) United States
(12) Patent Application Publication
(10) Pub. No.: US 2023/0230281 A1
(43) Pub. Date: Jul. 20, 2023

(54) METHOD FOR CALIBRATING THE ALIGNMENT OF CAMERAS

(71) Applicant: Robert Bosch GmbH, Stuttgart (DE)

(72) Inventors: Christopher Herbon, Weil Im Schoenbuch (DE); Johannes Peter Berger, Leonberg (DE)

(21) Appl. No.: 18/152,219

(22) Filed: Jan. 10, 2023

(30) Foreign Application Priority Data
Jan. 18, 2022 (DE) 10 2022 200 517.1
Dec. 22, 2022 (DE) 10 2022 214 334.5

(51) Int. Cl. G06T 7/80; G06T 7/35; G06T 7/37

(52) U.S. Cl. CPC G06T 7/80; G06T 7/35; G06T 7/37; G06T 2207/30252; G06T 2207/30244

(57) ABSTRACT

A method for calibrating a multiplicity of cameras on a vehicle in a common coordinate system. The method includes: a) acquiring camera images using each camera of the multiplicity of cameras, b) ascertaining overlap regions of camera images acquired in step a), c) setting up a common optimization function, which describes the alignments of each camera of the multiplicity of cameras as a target variable of the optimization, based on the overlap regions, d) solving the common optimization function set up in step c) to ascertain the alignments of each camera.

### CROSS REFERENCE

The present application claims the benefit under 35 U.S.C. § 119 of German Patent Application Nos. DE 10 2022 200 517.1 filed on Jan. 18, 2022, and DE 10 2022 214 334.5 filed on Dec. 22, 2022, which is expressly incorporated herein by reference in its entirety.

### FIELD

The present invention relates to a method for calibrating the alignment of a multiplicity of cameras on a vehicle. In addition, a computer program for carrying out the method, a machine-readable memory medium having the computer program, and a control device for carrying out the present method are provided according to the present invention.

### BACKGROUND INFORMATION

These days, many modern vehicles are equipped with cameras, which are required for different functions such as lane-keeping assistants or adaptive cruise control systems. These functions require the cameras to be able to identify objects from the real world and to exactly enter them into an internal map of the environment. This map preferably describes the environment of the vehicle in a type of bird's-eye-perspective or 3D environment map. For this to function precisely, the camera must be calibrated, that is, its exact position and orientation relative to the vehicle be known.

While cameras that are aligned to or counter to the driving direction can easily be calibrated while driving takes place because the vanishing point lies within the image, this becomes much more difficult for cameras that are pointing to the side. FIG. 1 exemplarily shows cameras whose absolute calibration with regard to the environment (the real world) can be accomplished quite well, and also other cameras, which usually require a relative calibration (relative to other cameras) for a robust calibration.

For that reason, a relative calibration of the cameras with respect to one another is used instead of calibrating laterally aligned cameras in absolute terms relative to the world. The first step in this process is to virtually rectify the common field of view of the cameras (overlap region). This is shown in FIG. 4, for example. The term ‘rectification’ describes a type of equalization or removal of distortions from the camera image. After the rectification, the common overlap region is extracted in an approximation on the one hand, and the projection of the images is adapted in such a way that the image content has the greatest possible geometrical similarity on the other hand. For example, rotations are compensated (the image is situated perpendicular to the road), and the proportions of the scene in the two images are similar.

This process is always performed in pairs for all individual overlap regions. Each estimate supplies a relative position and orientation between the camera to be calibrated and the reference camera.

As a matter of principle, each overlap region is suitable to supply a relative pose (“delta pose”), that is, the difference in the position and orientation between the cameras. For instance, it is nearly always possible to ascertain more relative poses than cameras to be calibrated. Here, the term ‘pose’ in particular includes the “alignment” of a camera. The term ‘pose’ may basically describe a combination of the position and the orientation or alignment. Thus, a relative pose may also be described as a relative alignment of a camera or a viewing direction of a camera relative to another camera or to a viewing direction of another camera. Mathematically speaking, this is an over-determined system, especially when a greater number of overlap regions and image contents that are allocatable to one another exist in the overlap regions. To find a calibration for a side camera, it is therefore necessary to harmonize the individual delta poses to a single camera pose after the fact. This is shown in FIG. 2 by way of example.

In other words, all delta poses between the camera to be calibrated and all other cameras that overlap with the field of view of precisely this camera are combined into a single delta pose. This process may have the result that errors are simply distributed instead of finding the best possible measurement of the delta pose.

In summary, there are multiple disadvantages in the relative calibration:
The overlap regions are often relatively small. If an attempt is made to estimate the relative pose between two cameras, an error is made. This also means that the relative calibrations (from multiple overlap regions) are not necessarily well matched. On the one hand, this indicates that calibration errors have already occurred at this point, and no direct decision can be made as to which pose is the best on the other hand.
To resolve the over-determination, it is therefore necessary to average the delta poses. The calibration error of the individual delta poses is merely distributed in the process. Since this is only a heuristic method, the calibration may worsen in a worst-case scenario, e.g., if a camera has previously already been satisfactorily calibrated relative to another camera.
If this method is used for more than one side camera, a calibration error may propagate to an increasing extent to other cameras, especially when the overlap regions are very small (lever effect).

### SUMMARY

Starting from such a scenario, a method according to the present invention for calibrating the alignment of a plurality of cameras on a vehicle in a common coordinate system will be described here. According to an example embodiment of the present invention, the method includes the following steps:
a) Acquiring camera images using each camera of the multiplicity of cameras;
b) Ascertaining overlap regions of camera images acquired in step a);
c) Setting up a common optimization function, which describes the alignments of each camera of the multiplicity of cameras as a target variable of the optimization, based on the overlap regions;
d) Solving the optimization function set up in step c) to ascertain the alignments of each camera.

To carry out the present method, the steps a), b), c) and d) may be executed at least once and/or repeatedly in the indicated sequence, for instance. In addition, the steps a), b), c) and d) may at least partly be carried out in parallel or simultaneously.

According to an example embodiment of the present invention, in step a), each camera of the multiplicity of cameras acquires camera images. The acquisition may generally relate to the recording of real (digital) image representations with the aid of the respective camera. Moreover, the acquisition may also include the postprocessing of recorded (raw) camera sensor data, so that it is possible to provide camera images in which two adjacent cameras cover a similar image region or image content in each case. In other words, this can especially also be described in such a way here that step a) may encompass also an acquisition of virtual camera images that are or were ascertained on the basis of actually recorded camera images.

In step b), overlap regions of camera images acquired in step a) are ascertained.

Preferably prior to step b) or during step b), a rectification of the camera images may be carried out for an ascertainment of the overlap regions. In this context, virtual views, for example, are able to be generated so that two adjacent cameras have a similar image region or image content in each case. Put another way, this may particularly also be described in such a way that virtual views are generated here based on real images acquired in step a), so that the focus can selectively be placed on overlapping image regions or matching image content that can be acquired by mutually adjacent cameras.

As an alternative or in addition, according to an example embodiment of the present invention, it may be provided to generate virtual views, in particular between the steps b) and c), so that two adjacent cameras have a similar image region or an overlap region in each case. More specifically, a rectification of the images from two adjacent cameras may be carried out in each case so that they show a similar image content (virtual views). For example, this may include the existence of multiple rectifications for a single camera, depending on the given overlap with other cameras. In addition, a determination of corresponding pixels (optical flow) between two rectified images or generated virtual views may be carried out in each case.

In step c), a common optimization function is set up based on the overlap regions, which describes the alignments of each camera of the multiplicity of cameras as a target variable of the optimization. In the process, in particular the correspondences of multiple overlap regions are able to be merged in an optimization function.

In step f), the common optimization function set up in step c) is solved to ascertain the alignments of each of the cameras. In the process, for example, it is also possible to solve the common optimization function set up in step c) in order to ascertain the pose of each camera. For instance, an optimization of the target function can be performed for this purpose, which may be dependent on the underlying camera setup.

According to an example embodiment of the present invention, it is particularly advantageous if the common coordinate system is a vehicle coordinate system. The vehicle, for instance, may be a motor vehicle such as an automobile. The vehicle may be set up especially for an at least partly automated or autonomous driving operation. In particular, all cameras are able to be calibrated with regard to a common coordinate system. This is usually the coordinate system of the damped mass (sprung mass). A coordinate system of this type is described in DIN/ISO 8855, for instance, but is not restricted to such a system.

According to an example embodiment of the present invention, it is also advantageous if a rectification of the camera images is implemented. For example, prior to ascertaining overlap regions in step b), a rectification of the camera images may be performed. Basically, the rectification may (alternatively or additionally) also take place in step b) or between the steps b) and c). In particular, the ascertainment of overlap regions may encompass at least one rectification. As an alternative or in addition, one rectification can be performed to ascertain overlap regions.

According to an example embodiment of the present invention, in the sense of the method provided here, it is therefore basically possible to allow an (additional) rectification, which usually makes the entire modeling more complex. In exchange, more robust algorithms may advantageously be obtained because the determination of the correspondences in rectified images is normally easier and thus advantageously also suitable for embedded software.

In the described method, different calibration types are able to be coupled and the dimension and runtime of the optimization problem be reduced as a result. The special rectification makes it possible to couple cameras of different designs with one another, which constitutes a generalization and an especially advantageous aspect.

The present invention provides a method for an online calibration of cameras of different designs as well as a different installation position and orientation. In this context, the term ‘online calibration’ especially means that the calibration is able to be performed repeatedly while the vehicle is in operation so that calibration errors that newly occur in particular during the operation are able to be identified and corrected. The term ‘online’ in particular also relates to the automatic calibration of the cameras during a driving operation without knowledge of the environment and without the presence of calibration markers in the world. Although each camera is usually already calibrated during the production of the vehicle, a continual calibration is required, nevertheless. On the one hand, the alignment of the camera changes in the long run due to aging and environmental effects, and on the other hand, short-term effects also play a role such as the ambient temperature or restoring errors of movable parts (e.g., exterior mirrors and doors). In addition, however, an online calibration may also be used for the calibration during the production.

The only requirement is that the cameras aligned toward the side have a sufficiently large overlap region (approximately 20% of the field of view) and the rough installation position be known. In addition, the present invention improves existing methods for a relative online calibration as far as all points are concerned that were mentioned above as disadvantages. Our new method allows for the calibration of all cameras relative to one another within what is referred to as a camera circle. In this context, a camera circle describes a larger number of cameras installed in a distributed fashion around the vehicle. In addition, this relative calibration of the cameras may be linked with a calibration of individual cameras with respect to the world.

It is unimportant in this context which opening angles the cameras have as long as a certain overlap region (common field of view) is present between the cameras. This method explicitly allows for the use of a rectification for each overlap region so that the images show similar image sections, as illustrated in FIG. 4. In this way, both a calibration between two fisheye cameras as well as between fisheye cameras and telecameras is able to be determined. However, the present method is not restricted to the use of the rectification, but functions also based on the original images of the camera.

A main advantage of the described method of the present invention is that the relative calibration of a camera is determined directly and simultaneously with respect to all cameras having a shared overlap region with this camera. This is achieved by solving the calibration in a common optimization problem. This not only improves the estimate of the calibration but also dispenses with the step of a heuristic harmonization and averaging, which is mathematically unfounded.

A further advantage of the method of the present invention is that the runtime, that is, the required number of arithmetic operations, of the entire calculation on a control device is increased only negligibly and thus functions on embedded hardware. Since the simultaneous optimization of all side cameras has a lower variance across all overlap regions, the calibration process can also be accelerated.

In addition, the entire mathematical problem of modeling is simplified. In existing methods, the calibration is calculated between rectified images and not based on the original images. This poses a problem if the rectification rule for the overlap region with multiple other cameras differs, e.g., because a smaller image region is used (virtual zoom). In such a case, the reference system of the calibration changes. That means that it no longer possible to directly compare the new calibration measurements to the previous measurements.

If such a change in the rectification is to be considered, the mathematical modeling becomes unnecessarily more complicated. However, if all cameras are simultaneously calibrated with respect to a fixed reference, the process is independent of the rectification rule. This increases the accuracy of the calibration and allows for the mutual calibration of cameras featuring quite different optical systems.

According to an example embodiment of the present invention, it is particularly advantageous if the alignment of each individual camera in the method is described by a rotation matrix, which describes the alignment of the camera relative to the common coordinate system. As an alternative or in addition, further representations of the rotations such as via unity quaternions are also possible.

In addition, according to an example embodiment of the present invention, it is advantageous if the optimization function includes a system matrix, which describes the relative alignment of the cameras with respect to each other in the form of variables that are identified with a minimal error when the optimization function is solved in step d). As alternative or in addition, it is also possible to use methods without a system matrix such as line search or gradient methods.

Moreover, according to an example embodiment of the present invention, it is advantageous if an optimization that is at least of the second order is carried out to solve the optimization function. This may advantageously contribute to an increase in the convergence rate.

According to an example embodiment of the present invention, it is advantageous, in particular, if a Gauss-Newton algorithm or a Levenberg-Marquardt algorithm is used to solve the optimization function.

In addition, according to an example embodiment of the present invention, it is advantageous if the multiplicity of cameras forms a camera circle. For example, multiple cameras can be placed around the vehicle in a distributed fashion to form the camera circle (and be aligned in different directions from one another). More specifically, the cameras of the camera circle may at least partly or completely cover the environment of the vehicle.

According to an example embodiment of the present invention, when setting up the optimization function, it is furthermore advantageous if absolute alignment information is inserted into the common coordinate system for at least one camera (or multiple cameras or all cameras) of the multiplicity of cameras. The absolute alignment information may be inserted from an external source, for example.

According to an example embodiment of the present invention, the external source may be any data source other than the camera. Map data, navigation data or similar data, for instance, are able to be incorporated into the present method as an external (data) source.

According to an example embodiment of the present invention, it is particularly advantageous if pixels in the overlap region of different camera images are allocated to one another when setting up the common optimization function in step c). The camera images may be real recordings or at least partly be virtual camera images (generated on the basis of real recordings).

Different possible details of an algorithm for carrying out the described method will be described in the following text.

To begin with, the scenario of a side camera will be described and illustrated, which is to be calibrated relative to a front and rear camera. Let it be assumed that the latter is already accurately calibrated with regard to the world (a preprocessing step for the introduced method).

To this end, P denotes the pose (or alignment) to be estimated, which is described by a three-dimensional rotation matrix R and a three-dimensional displacement vector t. Mathematically, poses are representable in the form of 4×4 matrices.

$$P ( R , t ) = ( \begin{matrix}R & t \\ 0 & 1\end{matrix} ) \qquad ( 1 )$$

They are linked to one another via the matrix multiplication. The linking of two poses is another pose. Since it is always possible to invert these matrices, noted as P⁻¹, this furthermore involves a group operation. It is possible to apply a pose and then the corresponding inverted pose. A change back to the original coordinate system is implemented in this way.

In the following text, upper and lower case letters are used to denote the different coordinate transformations: For three coordinate systems X, Y and Z, ^{Y}P_{X} denotes a transformation of a pixel from system X to Y. If a further transformation ^{Z}P_{R} is present, then it is able to be multiplied from the left up to the previous transformation. The coordinate system Y “is reduced therefrom” in the process:

^{Z}p_{X}=^{Z}p_{Y}^{Y}p_{X} (2)

The error function ϵ (P, x, y) will describe a random positive error function, which calculates an epipolar error.

The term ‘epipolar error’ comes from the field of epipolar geometry (also referred to as beam geometry). For each camera, a polar coordinate system which has its origin in the camera projection center is able to be described. The alignment or pose of the camera extends from this projection center. Deviations between the actual pose or alignment and an estimated or assumed pose or alignment may be referred to as “epipolar errors”.

In this context, x is the projection of a (fixed) world point from the viewpoint of a camera, and y is the corresponding projection of an adjacent camera.

If P is the exact relative transformation between the cameras, then the epipolar error function has the value 0, which is the optimal value. In general, the following applies: the smaller the value of this function, the better the match between the parameters. If many corresponding pixels (x, y) have now been found between both images (e.g., optical flow), then the error function is able to be added up and minimized with regard to the parameters of pose P.

The used minimization method for minimizing errors is basically freely selectable, and the method is not restricted to the application of a minimization method. In the same way, the precise parameterization of pose P is not relevant here. Instead, it is a matter of how the optimization problem is modeled to allow for a robust common calibration of all side cameras.

Here, ^{U}^{ᵢ}P_{F} describes the transformation of a random point in the world in the vehicle coordinate system F into the camera coordinate system Uᵢ of an uncalibrated camera Kᵢ. Here, a vehicle coordinate system refers to the common coordinate system, which in particular is fixedly situated with regard to the chassis of the vehicle. The origin of this coordinate system may be the center point of the rear axle, for example, and the orientation may be aligned in a straight line toward the front. In this context, reference may be made to DIN/ISO 8855 by way of example. In an advantageous manner, the coordinate system of the damped mass (sprung mass) may particularly form a suitable reference system.

For the execution of the described method, it is preferably assumed that the positioning and orientation of the camera to be calibrated are known down to a few degrees and centimeters. This information is known from the technical data of the vehicle, for example, or from a previously performed calibration during the production of the vehicle.

The now to be determined calibration is indicated here as the difference from a previously known calibration (pre-calibration or factory-side calibration) and denoted as

$${}^{{K}_{i}} {P}_{{U}_{i}}^{Δ} .$$

Since this involves only a minor correction, a delta Δ has been inserted in order also to indicate that this pose is to be estimated. Finally, to calculate the pose between camera Kᵢ and Kⱼ, it is preferably also possible to take the rectification into account, which is denoted by a virtual pose

$${}^{{V}_{i \to j}} {P}_{{K}_{i}} .$$

As a whole, the following representation is obtained as a result, which may also be referred to as a pose decomposition:

$${}^{{V}_{i \to j}} {P}_{F} = {}^{{V}_{i \to j}} {P}_{{K}_{i}} {}^{{K}_{i}} {P}_{{U}_{i}}^{Δ} {}^{{U}_{i}} {P}_{F} \qquad ( 3 )$$

It is possible to conceive of approaches in which none of these poses or alignments in the common coordinate system are estimated directly. Instead, the relative pose and alignments between the virtual cameras are estimated, or in other words:

$${}^{{V}_{j \to i}} {P}_{{V}_{i \to j}} : {J}_{j \to i} ( {}^{{V}_{j \to i}} {P}_{{V}_{i \to j}} ) : = {\sum }_{( x , y ) ∈ {Ω}_{i \to j}} ϵ ( {}^{{V}_{j \to i}} {P}_{{V}_{i \to j}} , x , y ) \qquad ( 4 )$$

Here, index i denotes a side camera, and j is the index of an already calibrated camera, and Ωⱼ₋ᵢ is the set of all image correspondences between the virtual cameras Vᵢ and Vⱼ.

Let it be assumed that there are two calibrated cameras, i.e., a front and rear camera (i∈{0, 2}) as well as a side camera which is pointing to the left (j=1). The optimal solutions of the problem then would be

$${}^{{V}_{1 \to 0}} {P}_{{V}_{0 \to 1}} and {}^{{V}_{1 \to 2}} {P}_{{V}_{2 \to 1}} .$$

However, several aspects of this approach are problematic:
The poses are calculated between virtual cameras and must subsequently be calculated back to the actually desired pose

$${}^{{K}_{j}} {P}_{{U}_{j}} .$$

The poses are highly dependent on the rectification. If the rectification rule is changed during the calibration process, then the reference no longer fits.
There are now two poses instead of one desired pose, that is, an over-determined system. However, since the individual optimization problems operate on only very narrow overlap regions, the estimations have a high systematic error (bias).
In the case of multiple side cameras which have no direct overlap region with an already calibrated camera, it is not clear how the ascertained poses are to be offset. If one side camera is already perfectly calibrated but another camera is highly decalibrated, then the error is distributed. This means that both will then exhibit half the calibration error, which constitutes a worsening for the already calibrated camera.

Here, the modeling of a common optimization function with reference to the common coordinate system (vehicle coordinate system) is now provided. Rather than solving the function (4) twice to determine the alignment of the side camera relative to the front camera and the rear camera, which would lead to an inconsistent solution that would have to be harmonized, this modeling is achieved by determining a single common optimization problem (a common optimization function). A pose decomposition (3) is used for this purpose. Poses ascertained by the pose decomposition may be considered “virtual cameras” which correspond to the decomposed poses and are able to be directly coupled with one another in the common optimization function:

$${}^{{V}_{i \to j}} {P}_{{V}_{j \to i}} = {}^{{V}_{i \to j}} {P}_{F} {}^{F} {P}_{{V}_{j \to i}} = {}^{{V}_{i \to j}} {P}_{{K}_{i}} {}^{{K}_{i}} {P}_{{U}_{i}}^{Δ} {}^{{U}_{i}} {P}_{F} {( {}^{{U}_{j}} {P}_{F} )}^{- 1} {( {}^{{K}_{j}} {P}_{{U}_{j}} )}^{- 1} {( {}^{{V}_{j \to i}} {P}_{{K}_{j}} )}^{- 1} = : {G}_{j \to i} ( {}^{{K}_{i}} {P}_{{U}_{i}}^{Δ} , {}^{{K}_{j}} {P}_{{U}_{j}}^{Δ} )$$

In this equation, the function was additionally inserted, which now depends purely on the calibration poses to be found.

If camera i is already calibrated, that is,

$${{K}_{i}}^{} {P}_{{U}_{i}}^{Δ}$$

is known, then it is possible to insert the corresponding values here, and the function then depends only on pose

$${{K}_{j}}^{} {P}_{{U}_{j}}^{Δ} .$$

In the case of one calibrated and one uncalibrated camera, this is illustrated in FIG. 5. One detail still needs to be clarified. A priori, it is of course impossible to already set up the virtual cameras in relation to the calibrated cameras since the calibration must still be estimated first. Instead, the initial extrinsic details of the camera are used (e.g., from CAD data), which are roughly correct and sufficient for extracting the overlap region. In other words, a transformation

$${}^{{V}_{0 \to 1}} {P}_{{U}_{0}}$$

is used here. However, this pose may in turn be expressed as

$${}^{{V}_{0 \to 1}} {P}_{{U}_{0}} = {}^{{V}_{0 \to 1}} {P}_{{K}_{0}} {{K}_{0}}^{} {P}_{{U}_{0}}^{Δ} \qquad ( 5 )$$

With the aid of the described method, it is possible that the virtual view (the rectification) has to be calculated only once at the outset. As a rule, the rectification is mathematically not exact and produces a new error. The correction of this less than perfect transformation is implemented implicitly and automatically by the present method or optimization or by solving the common optimization function. It can furthermore be exactly indicated to which camera the correction

$${{K}_{0}}^{} {P}_{{U}_{0}}^{Δ}$$

must be applied, especially if multiple overlap regions are used (as described further below).

Here, a better cost function/optimization function for the application case of a calibrated rear and front camera and an uncalibrated side camera j is to be provided as well. It is denoted by

$${J}_{j} ( {{K}_{j}}^{} {P}_{{U}_{j}}^{Δ} ) : {J}_{j} ( {{K}_{j}}^{} {P}_{{U}_{j}}^{Δ} ) := {\sum }_{i ∈ \{ 0 , 2 \}} {\sum }_{( x , y ) ∈ {Ω}_{j \to i}} ϵ ( {G}_{j \to i} ( {{K}_{i}}^{} {P}_{{U}_{i}}^{Δ} , {{K}_{j}}^{} {P}_{{U}_{j}}^{Δ} ) ; x , y ) \qquad ( 6 )$$

It should be noted in this context that the first sum runs across the two calibrated cameras 0 and 2, and the individual optimization problems are thus consolidated. As a result,

$${{K}_{i}}^{} {P}_{{U}_{i}}^{Δ}$$

for i∈{0, 2} is also known. This cost function may therefore be minimized with regard to

$${{K}_{j}}^{} {P}_{{U}_{j}}^{Δ} .$$

This is the sought calibration of the side camera. Subsequent averaging, as implemented in other approaches, is not required. Since both existing overlap regions are taken into account, the systematic error is minimized in addition.

To simplify the following formulas, the following abbreviation will now be used:

$${η}_{j \to i} ( {{K}_{i}}^{} {P}_{{U}_{i}}^{Δ} , {{K}_{j}}^{} {P}_{{U}_{j}}^{Δ} ) := {\sum }_{( x , y ) ∈ {Ω}_{j \to i}} ϵ ( {G}_{j \to i} ( {{K}_{i}}^{} {P}_{{U}_{i}}^{Δ} , {{K}_{j}}^{} {P}_{{U}_{j}}^{Δ} ) ; x , y ) \qquad ( 7 )$$

Another great advantage of the modeling (6) is that it is scalable as desired. If not only two calibrated cameras exist but many i∈Kⱼ, where Kⱼ denotes an index set of calibrated cameras having an overlap region with camera j, then camera j is able to be calibrated thereby as well. To do so, it is simply necessary to switch out the index set of the first sum in (6):

$${J}_{j} ( {{K}_{j}}^{} {P}_{{U}_{j}}^{Δ} ) := {\sum }_{i ∈ {K}_{j}} {η}_{j \to i} ( {{K}_{i}}^{} {P}_{{U}_{i}}^{Δ} , {{K}_{j}}^{} {P}_{{U}_{j}}^{Δ} ) \qquad ( 8 )$$

It should be noted in this context that the function (8) actually depends only on the pose

$${{K}_{j}}^{} {P}_{{U}_{j}}^{Δ}$$

because the other delta poses (for the index i) are already known. Thus, there is only one solution for camera j.

In classic approaches, where each camera would be calibrated individually, each further camera would in turn generate a new solution, which would have to be averaged in a time-consuming and incorrect manner. In addition, the approach described here does not result in any significantly longer total runtime on a control device because it still uses the same number of correspondences (x, y), and the optimization has the same number of estimation parameters in this case. What is improved, however, is the reduction of the systematic error and thus the mean variation of the individual calibration measurements across a longer period of time.

In the following text, the described matter is to be generalized to random camera configurations. To this end, the set of the already calibrated cameras featuring an overlap region with camera Kⱼ is once again described by Kⱼ, and U describes the set of uncalibrated cameras. In this way, it is not only possible to allow for the calibration of an individual side camera but for a random number of cameras. For this purpose, the function (8) is summed across all cameras to be calibrated. The resulting optimization problem consists of minimizing the following sum:

$${Σ}_{j ∈ U} {J}_{j} ( {{K}_{j}}^{} {P}_{{U}_{j}}^{Δ} ) \qquad ( 9 )$$

However, this modeling is not yet complete. Here, all cameras are now calibrated relative to already calibrated cameras, which means that the problem is split up into individual optimization problems for each camera. An essential term that calibrates uncalibrated cameras with one another is therefore still missing. This is one of the central problems of classic modeling, which requires already calibrated reference cameras.

If these are unavailable, it is not clear how to handle the individual estimations afterwards.

The approach described here solves this problem in that it permits a coupling term between uncalibrated cameras. Here, Uⱼ denotes the set of all uncalibrated cameras that have an overlap with camera j. In the process, the calibration deltas of the individual cameras in the optimization problem are directly estimated once again.

$${{F}_{j} ( {{K}_{j}}^{} {P}_{{U}_{j}}^{Δ} , {(}^{{K}_{i}} {P}_{{U}_{i}}^{Δ} )}_{i ∈ {U}_{j}} ) := {\sum }_{i ∈ {U}_{j}} {η}_{j \to i} ( {{K}_{i}}^{} {P}_{{U}_{i}}^{Δ} , {{K}_{j}}^{} {P}_{{U}_{j}}^{Δ} ) \qquad ( 10 )$$

In this coupling of multiple uncalibrated cameras, it should be noted that an optimization must now be achieved not only with regard to a single camera but that the parameters of all uncalibrated cameras are to be estimated by a minimization. This increases the dimension of the optimization problem. For example, the optimization of a single camera requires the estimation of six parameters; for n cameras, this therefore means 6·n parameters.

If an optimization of the second order is performed, for instance with the aid of a Gauss-Newton algorithm, this will also be the order in the normal equation. A correspondingly large equation system must be solved. For a conventional multi-camera system, however, one would not have to proceed from this worst-case scenario because not all cameras to be calibrated typically have a common overlap region. This hold true especially if the described method is applied to a camera circle covering the entire environment of a vehicle (360°).

Thus, the corresponding system matrix will have individual blocks that receive no entries and therefore simplify the optimization. In addition, the coupling of all possible overlap regions minimizes the systematic error for the classic method, which is the primary goal of every calibration.

Lastly, the combination of the error functions will be examined. The terms (9) and (10) are summed for this purpose, and a single error function is obtained for all uncalibrated cameras:

$${G ( {(}^{{K}_{j}} {P}_{{U}_{j}}^{Δ} )}_{j ∈ U} ) := {\sum }_{j ∈ U} ( {J}_{j} ( {{K}_{j}}^{} {P}_{{U}_{j}}^{Δ} ) + {F}_{j} ( {{K}_{j}}^{} {P}_{{U}_{j}}^{Δ} , {( {{K}_{i}}^{} {P}_{{U}_{i}}^{Δ} )}_{i ϵ {U}_{j}} ) ) \qquad ( 11 )$$

The function now includes all possible couplings of the cameras. The inclusion of all cameras in the set U is explicitly permitted here, which means that no single camera is already calibrated with regard to the world. In such a case, no unique solution exists because all cameras can be rotated and shifted about a fixed point by a random rotation and translation without resulting in a change in the positions of the cameras relative to one another.

Two procedures are possible in this case: either one camera must be defined as calibrated and all other cameras are calibrated relative to this camera, or at least one camera is calibrated with regard to the world and then forms the reference for all other cameras.

A further special case is the situation where the problems are broken down into individual connected components such as uncalibrated cameras of the left and right side. There are two disjointed parts U=Uₗ∪Uᵣ in this case, that is, no couplings are used between left and right cameras. The optimization problem is therefore split into two smaller optimization problems, which considerably improves the runtime yet simultaneously still allows for the coupling of cameras on one side in each case.

It should also be mentioned as a further detail that the individual additive terms in function (11) may also be provided with positive weights ω_{j→1}, which express the influence of the corresponding term. For example, the weights of the function Jⱼ could be selected to be greater than those of the function Fⱼ because it may be assumed that the calibration between uncalibrated cameras is less robust. This depends on the respective application case, however.

Here, a few special design features of the described method are to be introduced, which are able to be applied in connection with the use of the described method for calibrating cameras of a camera circle.

One embodiment variant that deserves special protection is the use of the method in a system featuring a multitude of cameras having different opening angles and different alignments, only a few of which detect the vanishing point during a driving operation (see FIG. 1). In such a system, the present invention offers the greatest possible improvement potential because the number of laterally aligned cameras by far exceeds the number of cameras disposed to and counter to the driving direction.

The special essential advantage of the present method is illustrated in FIG. 5. The representation is restricted to the “simplest” case of two cameras, of which one is still not calibrated. The modeling is able to be expanded to any other number of cameras, although this would greatly complicate the graphics. However, the general case was described in the equation (11).

According to a further aspect of the present invention, a computer program is provided for carrying out a method introduced here. This relates in particular to a computer program (product), which includes instructions that induce a computer to carry out a method as described here when the program is executed by the computer.

According to a still further aspect of the present invention, a machine-readable memory medium is provided which has or stores the provided computer program. As a rule, the machine-readable memory medium is a computer-readable data carrier.

According to a further aspect of the present invention, a control device for carrying out a method as described here is also provided. For example, the control device may be a control device for a (motor) vehicle. The control device, for instance, may include a processor and/or controller, which is/are able to carry out instructions to execute the present method. To this end, the processor or controller may execute the provided computer program, for example. The processor or controller can access the provided memory medium to enable it to execute the computer program, for instance.

The details, features and advantageous refinements described in connection with the present method may correspondingly also be found in the provided computer program and/or the memory medium and/or the control device, and vice versa. In this regard, full reference is made to the respective comments for the more detailed characterization of the features.

In the following text, the introduced solution as well as its technical environment will be described in greater detail with the aid of the figures. It should be noted that the present invention is not meant to be restricted to the illustrated exemplary embodiments. Unless explicitly represented to the contrary, it is particularly also possible to extract partial aspects from the facts described in the figures and to combine them with other components and/or findings from other figures and/or the present description.

### BRIEF DESCRIPTION OF THE DRAWINGS

FIG. 1 shows a top view of an exemplary representation of a vehicle including a camera circle.

FIG. 2 shows a top view of a further exemplary representation of a vehicle having a plurality of cameras.

FIG. 3 shows an exemplary sequence of the method introduced here, according to the present invention.

FIG. 4 shows exemplary image representations to illustrate an advantageous aspect of the method according to an example embodiment of the present invention.

FIG. 5 shows a top view of a further exemplary representation of a vehicle having a multiplicity of cameras, according to the present invention.

### DETAILED DESCRIPTION OF EXAMPLE EMBODIMENTS

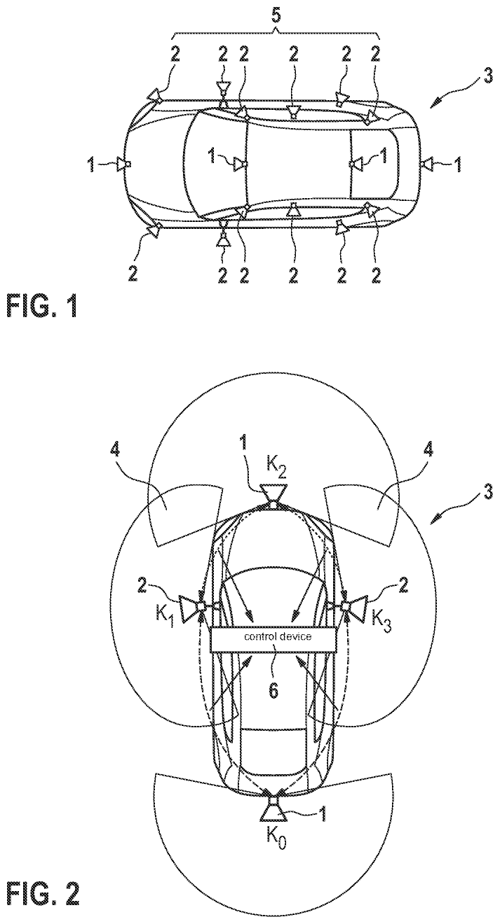

FIG. 1 schematically shows a top view of an exemplary representation of a vehicle 3 having a camera circle 5. In this context, FIG. 1 shows an exemplary system of video sensors on a vehicle. While front and rear cameras 1 are able to be calibrated in an exact and robust manner relative to the world, this is not possible in all situations and with the required accuracy and robustness for sideways-pointing cameras 2 while driving is taking place. The method introduced here can contribute to solving this problem.

FIG. 2 schematically shows a further exemplary representation of a vehicle 3 having a plurality of cameras 1, 2 in a top view. In this context, FIG. 2 exemplarily illustrates that in calibration methods according to the related art, side cameras 2 (K₁ and K₃) are able to be calibrated relative to front and rear camera 1 (K₂ and K₀). A calibration may be calculated for each overlap region 4 between two cameras 1, 2. This results in the existence of two calibrations for each side camera 2 (dotted and dashed lines). It is unclear, a priori, how these calibrations are to be offset against one another. This method presently uses a simple harmonization, which averages the error. However, this may also worsen an already calibrated overlap region 4. The introduced method is able to contribute to this solution as well.

By way of example, FIG. 2 also shows a control device 6, which may be or is developed to execute the described method.

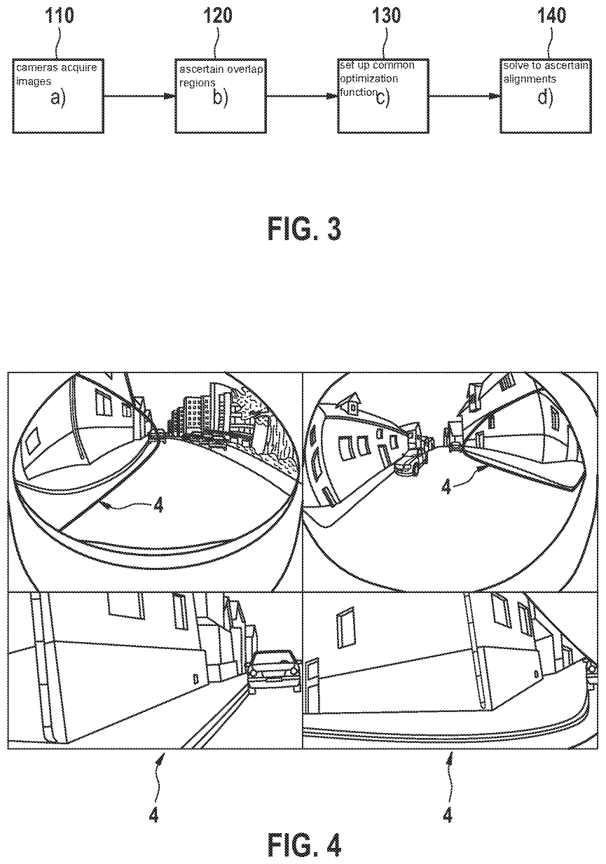

FIG. 3 schematically shows an exemplary sequence of the method introduced here. The sequence of steps a), b), c) and d) represented by blocks 110, 120, 130 and 140 serves as an example and may be cycled through at least once in the illustrated sequence, for instance. The method is used to calibrate the alignment of a multiplicity of cameras 1, 2 on a vehicle 3 in a common coordinate system. The common coordinate system may be a vehicle coordinate system, for instance.

In block 110, each camera 1, 2 of the multiplicity of cameras 1, 2 acquires camera images according to step a).

A rectification of the camera images may particularly be implemented in this context, for instance in such a way that virtual images are generated from original or real images (see FIG. 4).

In block 120, according to step b), overlap regions 4 of camera images acquired in step a) are ascertained.

In block 130, according to step c), a common optimization function is set up with the aid of overlap regions 4, which describes the alignments of each camera 1, 2 of the multiplicity of cameras 1, 2 as a target variable of the optimization.

For example, when setting up the optimization function for at least one camera 1 of the multiplicity of cameras 1, 2, absolute alignment information may be inserted in the common coordinate system.

As a further example, pixels in overlap region 4 of different (real or virtual) camera images are able to be allocated to one another when setting up the common optimization function in step c).

In block 140, according to step d), the common optimization function set up in step c) is solved to ascertain the alignments of each camera 1, 2.

To solve the optimization function, an optimization of at least the second order, simply by way of example, may be carried out. However, as an especially advantageous but likewise merely exemplary embodiment variant, a Gauss-Newton algorithm may be used to solve the optimization function.

For instance, the alignment of each individual camera 1, 2 is able to be described by a rotation matrix, which describes the alignment of camera 1, 2 in relation to the common coordinate system.

By way of example, the optimization function may include a system matrix, which describes the relative alignment of cameras 1, 2 relative to one another in the form of variables that are able to be identified with a minimal error when the optimization function is solved in step d).

FIG. 4 schematically shows an exemplary image representation to illustrate an advantageous aspect of the present method, i.e., a possible rectification. In this context, FIG. 4 shows, for example, original images (on top) and an associated rectification (at the bottom) of a rear and a right fisheye camera. The region marked in the above original view is the common overlap region 4. The virtual views shown at the bottom predominantly relate to overlap region 4.

Following the rectification (below), the images are clearly more similar, which is better for the subsequent image processing. For example, this is better for calculating the optical flow. Since these images are slightly rotated during the rectification, this can also be taken into account in the modeling of the calibration problem. The new approach described here simplifies the estimation of the calibration considerably and makes it more robust insofar as it estimates the real camera calibration and operates only indirectly on the virtual cameras.

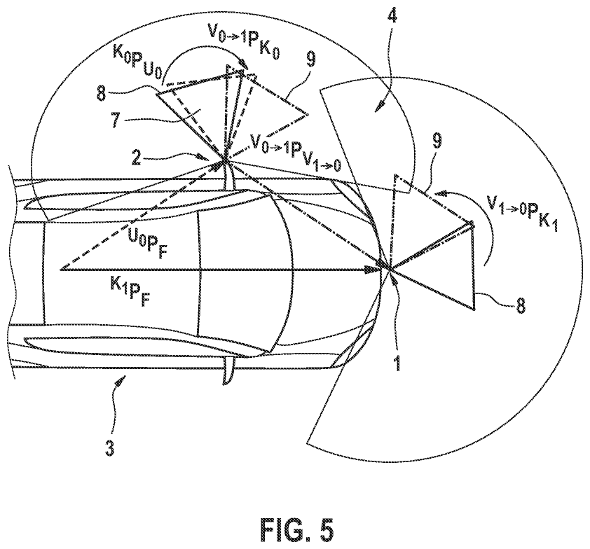

FIG. 5 schematically shows another exemplary representation of a vehicle 3 having multiple cameras 1, 2 in a view from above. FIG. 5 is specifically used to illustrate advantageous aspects of the new method described here.

FIG. 5 particularly illustrates the new problem modeling. While a direct calculation of the pose between the virtual cameras took place in the classic method (see virtual alignments 9 and dash-dotted arrow), the pose is now implicitly calculated via the concatenation of the poses and optimized with regard to the delta pose ^{K}^{⁰}P_{U}_{₀}. In this context, reference is made to the above equations for a more detailed explanation of the mathematical relationships. Here, it is assumed that camera 1 (the front camera) is already calibrated. The advantage is obvious. Instead of estimating an orientation of the virtual cameras relative to one another, the calibration of side camera 2 is estimated directly. This makes it possible to couple and jointly optimize any number of cameras. In FIG. 5, reference numeral 7 denotes uncalibrated alignments, reference numeral 8 denotes calibrated alignments, and reference numeral 9 denotes virtual alignments.

The described algorithm is preferably implemented in software. For instance, the advantage of the described method in comparison with a separate calibration of each camera can be recognized once a complete online calibration is performed (detectable by the diagnosis output). Subsequently, precisely one single side camera is deliberately rotated by a few degrees (approximately 3 to 5 degrees) in different directions so that the camera is now decalibrated. If conventional methods are then used for an individual calibration of cameras, this can be detected in that not only the camera itself, but also adjacent cameras no longer exhibit the same value as during the first calibration process because the error of 3 to 5 degrees propagates further and thus is distributed to other cameras. In contrast, due to the method described here, no difference can be detected if the introduced method is used, which discovers through the fusion of multiple cameras precisely which camera is decalibrated and automatically recalibrates it.

What is claimed is:

1. A method for calibrating a multiplicity of cameras on a vehicle in a common coordinate system, the method comprising the following steps:
a) acquiring camera images using each camera of the multiplicity of cameras;
b) ascertaining overlap regions of the camera images acquired in step a);
c) setting up a common optimization function, which describes alignments of each camera of the multiplicity of cameras as a target variable of the optimization, based on the overlap regions; and
d) solving the common optimization function set up in step c) to ascertain the alignments of each camera of the multiplicity of cameras.

2. The method as recited in claim 1, wherein the common coordinate system is a vehicle coordinate system.

3. The method as recited in claim 1, wherein a rectification of the camera images is implemented.

4. The method as recited in claim 1, wherein the alignment of each camera of the multiplicity of cameras is described by a rotation matrix, which describes the alignment of the camera relative to the common coordinate system.

5. The method as recited in claim 1, wherein the optimization function includes a system matrix, which describes relative alignment of the cameras relative to one another in the form of variables that are identified with a minimum error when the optimization function is solved in step d).

6. The method as recited in claim 1, wherein an optimization, which is at least of the second order, is performed to solve the optimization function.

7. The method as recited in claim 1, wherein a Gauss-Newton algorithm is used to solve the optimization function.

8. The method as recited in claim 1, wherein the multiplicity of cameras forms a camera circle in which the cameras cover at least a portion of an environment of the vehicle.

9. The method as recited in claim 1, wherein absolute alignment information is inserted into the common coordinate system for at least one camera of the multiplicity of cameras when setting up the optimization function.

10. The method as recited in claim 1, wherein pixels in the overlap region of different camera images are allocated to one another when setting up the common optimization function in step c).

11. A non-transitory machine-readable memory medium on which is stored a computer program for calibrating a multiplicity of cameras on a vehicle in a common coordinate system, the computer program, when executed by a computer, causing the computer to perform the following steps:
a) acquiring camera images using each camera of the multiplicity of cameras;
b) ascertaining overlap regions of the camera images acquired in step a);
c) setting up a common optimization function, which describes alignments of each camera of the multiplicity of cameras as a target variable of the optimization, based on the overlap regions; and
d) solving the common optimization function set up in step c) to ascertain the alignments of each camera of the multiplicity of cameras.

12. A control device configured to calibrate a multiplicity of cameras on a vehicle in a common coordinate system, the control device configured to:
a) acquire camera images using each camera of the multiplicity of cameras;
b) ascertain overlap regions of the camera images acquired in step a);
c) set up a common optimization function, which describes alignments of each camera of the multiplicity of cameras as a target variable of the optimization, based on the overlap regions; and
d) solve the common optimization function set up in step c) to ascertain the alignments of each camera of the multiplicity of cameras.
